(19) United States
(12) Patent Application Publication
(10) Pub. No.: US 2011/0190671 A1
(43) Pub. Date: Aug. 4, 2011

(54) Massage and/or Care Device Using a Jet of Droplets

(76) Inventors: Hervé Gourdin, Cucuron (FR); Marie-Odile Gourdin, Cucuron (FR)

(21) Appl. No.: 13/056,061

(22) PCT Filed: Jul. 28, 2009
(86) PCT No.: PCT/FR09/00939

§ 371 Date: Apr. 19, 2011

(30) Foreign Application Priority Data
Jul. 29, 2008 (FR) 0804318

(51) Int. Cl. A61H 7/00

(52) U.S. Cl. 601/15

(57) ABSTRACT

A device for providing massage and/or care by means of a jet of drops of liquid, the device comprising a liquid feed circuit (3) for feeding liquid at a pressure higher than atmospheric pressure and connected to a nozzle (1) emitting into the atmosphere a jet (2) of liquid divided into drops, and a heat source (4) and means (5, 6) for generating a flow of gas around the jet to transfer heat between the heat source and the drops.

The present invention relates essentially to a device for providing massage and/or care by means of a jet of liquid drops emitted by a nozzle, the device being suitable for being used by beauty and well-being or care professionals.

In order to project a jet of drops of a liquid, such as water, into an atmosphere, in particular air, nozzle spray systems have been proposed in which a circuit for feeding liquid at an “emission” pressure greater than atmospheric pressure opens out into said atmosphere via a hole or nozzle. The liquid leaving the nozzle is subjected to expansion that causes it to pass suddenly from the emission pressure to atmospheric pressure and that causes it to become divided into drops that are projected into the atmosphere. During this expansion, the drops of liquid emitted by a nozzle cool down. This cooling phenomenon is used in particular in the prior art for making artificial snow from cold water.

Nevertheless, although it is easy to cool the drops emitted by a nozzle, it is in practice impossible to heat such drops by heating the liquid before spraying it for the purpose of applications to massaging the human body. The expansion phenomenon predominates over heating prior to expansion and thus requires the liquid in the feed circuit to be heated to temperatures that can scald the skin. The safety conditions that are essential for use in massage are not satisfied, in particular when spraying is stopped, i.e. when the pressure in the nozzle feed circuit becomes insufficient to form drops and the jet takes on the shape of a cylindrical jet. Under such circumstances, cooling by expansion disappears and the liquid from the feed circuit is sent into the atmosphere at its hot temperature, thereby scalding the body that receives it.

Increasing the temperature of the drops of a jet emitted by a nozzle under conditions that are appropriate for massaging the human body thus constitutes a problem that remains to be solved in the prior art, in spite of the fact that the savings in water or liquid that result from using nozzles present a genuine advantage in this type of application.

It would also be particularly advantageous to control the temperature of the drops of a jet of water or liquid that is emitted by a nozzle in the context of protocols for providing care to the body by means of a jet of drops, in which the temperature of the drops and the force of the jet, or “indenting” of the skin, are varied while care is being performed.

Nevertheless, the temperature of the drops on the skin is colder than atmospheric temperature, in particular because of expansion. It also varies quickly with the nozzle feed pressure that determines the force of the jet and with the distance between the skin and the nozzle. The expansion nozzles of prior art devices are in practice not suitable for use in agreeable human body massage applications, even though they are economic in terms of water and inexpensive since they can be constituted by a calibrated hole.

The invention provides a device for providing massage and/or care of the human body by means of a jet of drops of liquid, the device comprising a liquid feed circuit for feeding liquid at a pressure higher than atmospheric pressure and connected to a nozzle emitting into the atmosphere a jet of liquid divided into drops, the device being characterized in that it includes a heat source, means generating a flow of gas around the jet for transferring heat between the heat source and the drops, and control means for controlling the heat source and the means generating the flow of gas in order to adjust the temperature of the drops of the jet to a desired value on reaching the human body.

According to other characteristics of the invention:

the means for generating the flow of gas are constituted by the wake of the jet, thereby sucking the gas towards the drops;

the means for generating the flow of gas comprise a fan propelling the gas towards the drops;

the means for generating the flow of gas comprise a duct arranged between the heat source and the drops;

the duct is cylindrical or frustoconical, at least in part;

the duct guides the gas flow in a direction that is substantially parallel to, that is inclined relative to, or that is substantially perpendicular to the mean direction of the jet;

the heat source comprises an electrical resistance; and

programmed or manual means are provided for varying the force of the jet and the temperature of the drops.

The advantages of the invention are, in particular, increased independence between emission pressure upstream from a nozzle emitting a jet of drops, the distance over which the drops are transported downstream from the nozzle, and the temperature of the drops downstream from the nozzle, while enabling feed nozzles to be used that are inexpensive and economical in liquid consumption, and under conditions of varying upstream liquid pressure and of downstream drop temperature that is substantially constant or that is adjusted to a desired value.

The invention can be better understood on reading the following description made by way of example with reference to the accompanying drawings, in which:

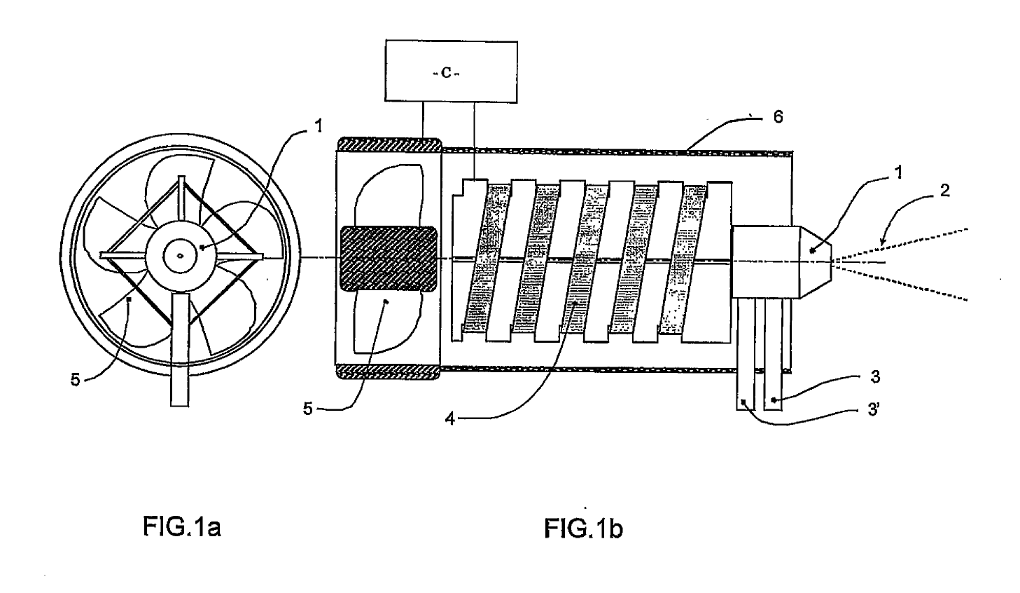

FIGS. 1a and 1b show a device of the invention using a fan and a coaxial duct guiding a flow of gas in a direction that is substantially parallel to the mean drop-emission direction;

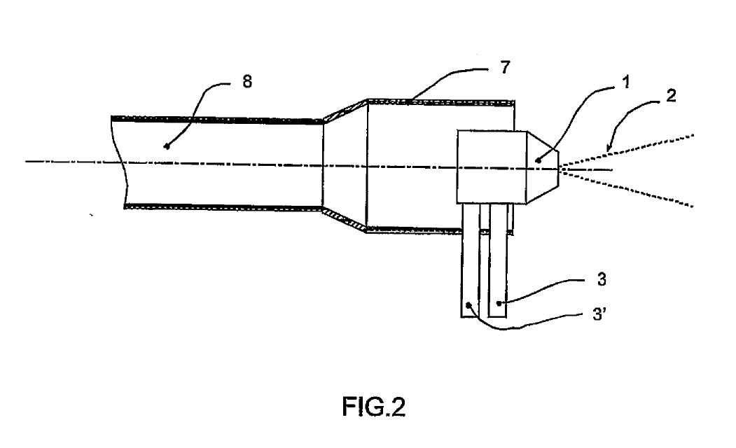

FIG. 2 shows a duct coaxial with the jet, the nozzle comprising a truncated cone and receiving a stream of hot air that is produced remotely;

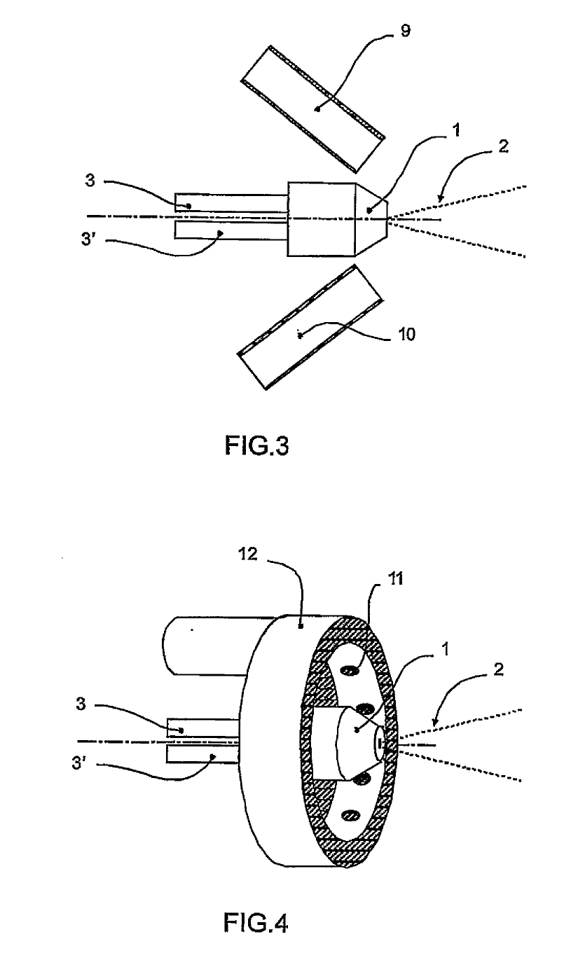

FIG. 3 shows a duct directing the gas flow in a manner that is inclined relative to the mean drop-emission direction; and

FIG. 4 shows a radial duct directing the gas flow perpendicularly to the jet of drops.

In the preferred embodiment shown in the drawings, the device of the invention comprises a fan and a duct that are used together and in association with a jet of drops of a liquid such as water in order to generate a flow of gas such as air that is directed against and around the drops, and in which an electrical resistance element is used as a source of heat. The nozzle is an air-water nozzle that makes it possible to obtain better stability, better directionality, and less dispersion in the sizes of the drops that are emitted. Nevertheless, it is possible for the device to make use of a water-only nozzle.

In FIG. 1, the embodiment shown comprises a spray nozzle 1 emitting a jet of drops 2 of a liquid that is water, into an atmosphere of air, an admission channel 3 for admitting liquid into the nozzle, and an admission channel 3′ for admitting air into the nozzle, a source of heat or heater element that is constituted by an electrical resistance 4, a fan 5, and a duct 6 surrounding at least the heater element and preferably the nozzle as far as the jet of drops, and electrical power supply and control means C for powering and controlling the resistance 4 and the fan 5. The duct conveys air between the heat source and the drops, contributing to forming an atmospheric flow and improving heat transfer between the heat source and the drops, when the air is either sucked towards the drops by the wake of the jet, or else is propelled towards the drops by the fan.

The shapes of the duct and the relative positions of the nozzle, of the heat source, and of the fan may be determined so as to optimize the transfer of atmosphere between the heat source and the drops. A frustoconical duct in which the nozzle is located serves for example to optimize this air transfer. It is possible by testing to determine the best positions for the fan, the heat source, and the nozzle, and also the length and the shape of the duct so as to optimize heat transfer between the heat source and the drops.

In the embodiment shown, the duct is in the form of a cylinder and has an inlet orifice and an outlet orifice in which the heater element is located, the nozzle being disposed at the outlet orifice and the fan at the inlet orifice. The drops are emitted entirely to the outside of the duct. In a variant, an extension of the duct can serve to produce drops in the duct and to propagate them in a portion thereof, in order to improve heat transfer.

In the absence of a fan and a duct, the wake of the jet, i.e. the air in contact with the drops of the jet, attracts surrounding air towards the drops and enables the invention to operate. The gas flow for heating the drops is then generated solely by said wake. Nevertheless, in this simple configuration, effectiveness as measured by the temperature rise of the drops is lower, and heat transfer is less effective.

When the duct is present without the fan being in operation, the temperature rise of the drops is greater and heat transfer is more effective, the gas flow being better formed by being guided by the duct.

It is with the duct and the fan in operation that the transfer of heat from the source towards the drops is the best.

It is thus possible to take advantage of the temperature contrast between operating the fan and stopping it in order to shorten the temperature response time of the device of the invention in order to optimize massage protocols.

With the fan, the thermal inertia of the heat source is minimized, which is advantageous when the temperature response time of the device is an important parameter.

In order to obtain a temperature range that is extended towards low temperatures and that is reached quickly, heat transfer is poorer without a fan, the jet sucking in non-heated air in this configuration and contributing to faster cooling of the jet. For this purpose, the duct may be frustoconical, with the nozzle being located in the vicinity of the small base and with the fan being located towards the large base of the truncated cone.

It is useful to observe that, because of its two orifices, the duct enables cool air to be admitted as well as expelling hot air into the atmosphere. The invention ensures a flow of air, it avoids stagnation, and with a heat source heating the air to a temperature that is sufficiently high, of the order of a few hundreds of degrees Celsius, it makes it possible to destroy any germs present in the atmosphere by purifying the air blown against the drops. The low temperature of the water admitted into the nozzle may also make it possible to avoid or limit any development of germs in the circuit for feeding water to the nozzle. In an embodiment of the invention, the nozzle is a combined air-water nozzle that is fed with air at a relative pressure of 0.3 bar and with water at relative pressure of 0.1 bar, the water flow rate being of the order of 1.5 liters per hour (L/h). The fan delivers air at a flow rate of the order of 50 liters per minute (L/min) and it is powered with electricity at 12 volts (V). The heater electrical resistance is powered with 24 V, the value of the resistance being 1 ohm (Ω) and its electricity consumption lying in the range 0 watts (W) (cold spray), 100 W (cool spray), to 250 W (hot spray).

The temperature of the drops when they reach the skin of a person lies in the range 32° C. to 47° C., approximately, which temperature may reach 47° C. when the jet is directed onto the person's back, and must not exceed 35° C. when it is directed onto the face.

Since the air of the gas flow is initially very hot, it can raise the water drops to a high temperature, e.g. close to 90° C. to 100° C., thereby sterilizing them.

The water of the drops cools very quickly on its path towards the skin, reaching the skin at a temperature lying in the range 35° C. to 47° C., with the distance between the nozzle 1 and the skin lying in the range 22 centimeters (cm) to 50 cm, approximately, depending on the type of massage or care being performed.

Controlling the electrical resistance 4 and the fan 5 makes it possible to go very quickly from hot to cold and vice versa, while taking care that the drops in the jet are not vaporized, so as to avoid any risk of scalding.

The size of the drops varies essentially as a function of the pressure of the air feeding the nozzle 1.

A relatively low air pressure serves to obtain drops that are larger, suitable for giving rise to a sensation of pressure on reaching the skin. A higher air pressure reduces the size of the drops and reduces or eliminates said sensation of pressure.

These variations in air pressure combined with variations in the temperature and the flow rate of the drops make it possible to obtain a wide range of different and contrasting sensations on a person's skin.

In FIG. 2, the duct 7 on the axis of the jet comprises a pipe of diameter that is smaller upstream from the nozzle than downstream or level with said nozzle, so as to provide an air flow section within the duct that is essentially constant, the pipe presenting a frustoconical shape where it changes diameter in order to minimize head losses. The hot air stream 8 feeding the duct may be produced remotely and the heat source may be remote, providing the heat losses that result from the remoteness of the heat source and from transporting heat are compatible with the heat transfer needed by the invention. In an embodiment of minimum length, the duct may be in the form of a truncated cone. The length of the pipe upstream or downstream from the constriction may be selected to be zero or short in auxiliary embodiments.

In the embodiments of FIGS. 1 and 2, the duct comprises at least one pipe guiding the atmosphere in a direction along the axis of or parallel to the mean propagation direction of the jet of drops. Other duct configurations are also possible, by inclining the atmosphere guide direction relative to the jet, by increasing the number of guide elements such as pipes that provide a certain amount of directional guidance, or such as mere holes, diffusing air and providing little directional guidance, and that can be considered as being pipes of zero length.

In FIG. 3, the duct is made up of a set of pipes 9, 10, there being two shown in the drawing, that converge towards the expansion zone or beyond. In this embodiment, the duct comprises at least one pipe guiding the atmosphere in a direction that is centripetal or that is inclined relative to the mean propagation direction of the jet of drops.

In FIG. 4, the duct 12 is annular, in the form of a torus or a tire inner tube, and it is provided with holes 11 for delivering air perpendicularly to the direction in which drops are emitted, upstream from or in a zone close to the nozzle. In this embodiment, the duct has at least one pipe guiding the atmosphere in a direction that is radial or perpendicular to the mean propagation direction of the jet of drops.

For short pipes, and in the limit for holes, the air guidance direction can be defined only by extension, a hole being suitable for diffusing air in a range of directions lying in an emission cone presenting a very wide angle at the apex.

It may be observed that the positioning of the various elements of the invention, i.e. the fan, the duct, and the heater element, upstream from the nozzle makes it possible to shorten or optimize the distance between the nozzle and the human body being massaged, compared with positioning these elements downstream from the nozzle. By enabling the human body to be placed at a shorter distance from the nozzle, the upstream positioning of the elements also enables the force of the jet to be maximized for a given nozzle feed pressure, and enables the cooling of the drops to be minimized by minimizing their path length and their exchange of heat in the atmosphere, for given heating power dissipated in the heater element.

Provision is also made to use a plurality of devices of the invention in a body care system fitted with independent means for controlling physical control parameters of such devices in order to provide a variety of care or massage programs. The term physical control parameters is used to cover the temperature of the heat source, the pressures of air and water in the nozzle, the speed of the fan, and the positioning of the nozzle in terms of its orientation and distance from the body.

Control may be performed by an operator or in automatic manner by a computer, implementing preprogrammed or programmed sequences, so as to vary the force of the jets and the temperature of the drops.

The invention is also applicable to making a hand tool for administering skin care. Under such circumstances, the physical control parameters are the temperature of the heat source, the pressures of air and water in the nozzle, the speed of the fan, and the positioning of the nozzle in terms of orientation and distance relative to the body, and they are adjusted by an operator so as to vary the force of the jet and the temperature of the drops.

The invention may thus include:

incorporating a plurality of drop heater devices in a body care system that is programmed to vary the force of the jets from the devices and the temperature of their drops; and

incorporating a drop heater device in a body care system with manual control of the force of the jet from the device and of the temperature of the drops.

The invention enables the drops of a jet from a nozzle to be heated so as to obtain a temperature for the drops that is reproducible and stable at a typical distance of twenty-five centimeters (distance between the human body and the nozzle), while allowing for inevitable variations in this distance due to movements of the body without giving rise to a sensation of cold as is perceived by the human body for a temperature variation of one degree Celsius.

The invention is applicable in particular to providing agreeable massage and care for the human body or a portion thereof, e.g. the face, foot, or back, by means of one or more jets of liquid drops.

1. A device for providing massage or care of the human body by means of a jet of drops of liquid, the device comprising a liquid feed circuit for feeding liquid at a pressure higher than atmospheric pressure and connected to a nozzle emitting into the atmosphere a jet of liquid divided into drops, the device further including a heat source, means generating a flow of gas around the jet for transferring heat between the heat source and the drops, and control means for controlling the heat source and the means generating the flow of gas in order to adjust the temperature of the drops of the jet to a desired value on reaching the human body.

2. A device according to claim 1, wherein the means for generating the flow of gas are constituted by the wake of the jet.

3. A device according to claim 1, wherein the means for generating the flow of gas comprise a fan propelling the gas towards the drops.

4. A device according to claim 1, wherein the means for generating the flow of gas comprise a duct arranged between the heat source and the drops.

5. A device according to claim 4, wherein the duct is cylindrical or frustoconical, at least in part.

6. A device according to claim 4, wherein the duct includes at least one means for guiding the gas in a direction that is substantially parallel to the mean direction of the jet, a direction that is inclined relative to the mean direction of the jet, or a direction that is substantially perpendicular to the mean direction of the jet.

7. A device according to claim 1, wherein the heat source comprises an electrical resistance.

8. A device according to claim 1, including programmed or manual means for varying the force of the jet and the temperature of the drops.
